(19) United States
(12) Patent Application Publication
(10) Pub. No.: US 2020/0171644 A1
(43) Pub. Date: Jun. 4, 2020

(54) ROTATABLE HANDLE

(71) Applicant: Canadian Tire Corporation Limited, Toronto (CA)

(72) Inventors: Tomasz Piotrowski, Toronto (CA); Michael Fuina, King City (CA); Victor Lai, Markham (CA)

(21) Appl. No.: 16/701,255

(22) Filed: Dec. 3, 2019

Related U.S. Application Data
(60) Provisional application No. 62/774,949, filed on Dec. 4, 2018.

(51) Int. Cl. B25G 1/06; A01B 1/02

(52) U.S. Cl. CPC B25G 1/06; A01B 1/026

(57) ABSTRACT

A handle is attachable to a shaft, for example, of a shovel. The shaft extends lengthwise along a shaft axis. The handle includes a collar defining an opening to receive the shaft, the collar rotatable about the shaft axis; a transverse arm extending along a transverse axis from a first end to a second end opposite the first end, the transverse arm rotatably connected to the collar at the first end; and a grip extending from the second end of the transverse arm. The grip is rotatable about the transverse axis and may be selectively axially movable along the transverse axis.

### FIELD

This relates to handle attachments, and more particularly, handle attachments for use with long-shaft hand tools such as long-handled shovels.

### BACKGROUND

A traditional hand tool such as a long-handled shovel may be used for digging, lifting and moving materials such as dirt or snow. Such shovels include a blade fixed to a shaft, and may be assembled with a fixed grip or handles attached to the shaft to be held by a hand of a user while the user grasps the shaft with another hand in use of the shovel for a manual shovelling activity.

The position of the shaft and such handles may restrict a user's hold of the shovel to certain configurations. In use, such configurations may thus cause a user to move in ways that result in strain on the user's body, for example, back strain and may cause spinal stress or even injury. Improvement is desired.

### SUMMARY

According to an aspect, there is provided a handle comprising: a collar defining an opening to receive a shaft extending lengthwise along a shaft axis, the collar rotatable about the shaft axis; a transverse arm extending along a transverse axis from a first end to a second end opposite the first end, the transverse arm rotatably connected to the collar at the first end; and a grip extending from the second end of the transverse arm, the grip rotatable about the transverse axis.

In some embodiments, the grip is selectively axially movable along the transverse axis.

In some embodiments, the transverse arm telescopes to extend and retract in length.

In some embodiments, the collar comprises two axially separated flanges fastenable to the shaft to constrain axial movement of the collar along the shaft axis.

In some embodiments, the collar comprises two clamshell collar halves, the two clamshell collar halves attachable to each other.

In some embodiments, each of the flanges comprises two clamshell flange halves, the two clamshell flange halves attachable to each other.

In some embodiments, the grip is a D-shaped handle.

In some embodiments, the shaft is connected to a fixed handle and a blade of a shovel.

In some embodiments, the collar is rotatable 120 degrees about the shaft axis.

Other features will become apparent from the drawings in conjunction with the following description.

### BRIEF DESCRIPTION OF DRAWINGS

In the figures which illustrate example embodiments,

FIG. 1 is a perspective view of a handle attached to a shaft, in accordance with an embodiment;

FIG. 2 is a cross-sectional view of the handle attached to the shaft of FIG. 1 along lines I-I;

FIG. 3 is a cross-sectional view of the handle attached to the shaft of FIG. 1 along lines II-II;

FIG. 4 is a perspective view of a handle attached to a shaft, in accordance with another embodiment;

FIG. 5A is a perspective view of the handle of FIG. 4;

FIG. 5B is a left side view of the handle of FIG. 4;

FIG. 6A is back view of the handle of FIG. 4;

FIG. 6B is a front view of the handle of FIG. 4;

FIG. 7A is a top view of the handle of FIG. 4; and

FIG. 7B is a bottom view of the handle of FIG. 4.

### DETAILED DESCRIPTION

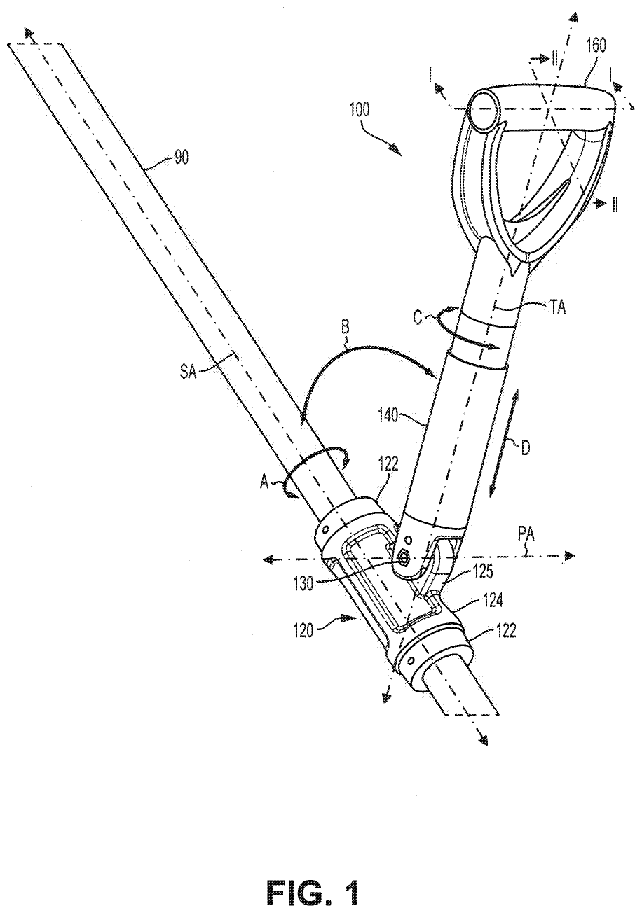

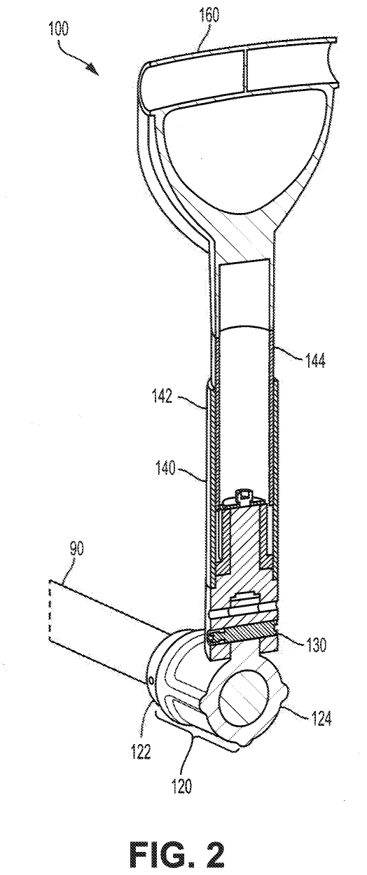

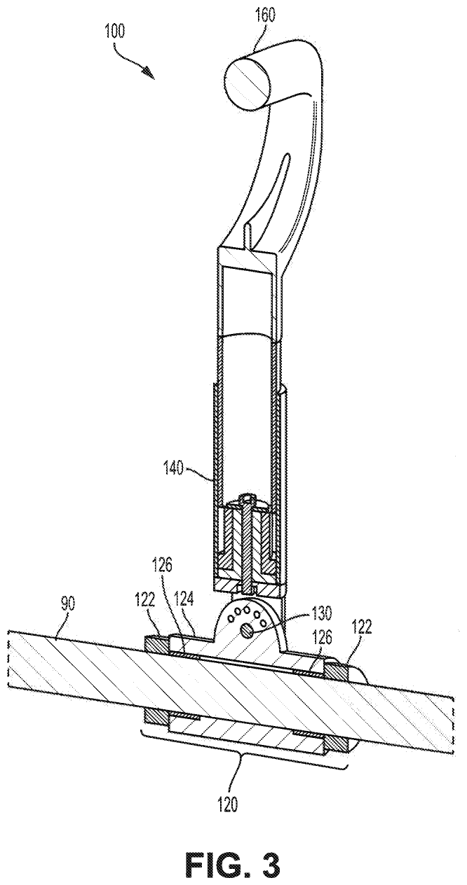

FIG. 1 is a perspective view of a handle 100 attached to a shaft 90, in accordance with an embodiment. FIG. 2 is a cross-sectional view of handle 100 attached to shaft 90 along lines I-I of FIG. 1. FIG. 3 is a cross-sectional view of handle 100 attached to shaft 90 along lines II-II of FIG. 1.

Shaft 90 may, for example, be generally cylindrical in shape as shown in FIGS. 1 to 4, extending lengthwise along a shaft axis SA. In some embodiments, shaft 90 may take the form of other shapes, such as a rectangular prism, or other suitable three-dimensional prism. In an example, shaft 90 may be 1.25 inches in diameter.

Shaft 90 may be formed of a material such as wood, polymers, metal or other suitable material.

Shaft 90 may be a shaft of a long-handled tool such as a shovel. For example, shaft 90 may have at a first end a fixed handle (not shown), and a blade (not shown) fixed at a second end, opposite the first end.

Handle 100 may be attachable to shaft 90 at a suitable position along the length of shaft 90, for example, at a desired distance from the blade so as to provide leverage between handle 100 and a fixed handle on one end of shaft 90 and a load applied to the blade on the opposite end of shaft 90.

As shown in FIG. 1, handle 100 may include a collar 120, a transverse arm 140 rotatably connected to collar 120 and a grip 160 extending from transverse arm 140.

Collar 120 of handle 100 includes flanges 122 and a collar body 124, and defines an opening to receive shaft 90.

In some embodiments, flanges 122 and collar body 124 may be each formed of two or more complementary clamshell halves to form collar 120 to attach to shaft 90 and circumscribe at least part of shaft 90, and extend axially along shaft axis SA. In some embodiments, flanges 122 and collar body 124 may be formed of two opposing and releasable components, so as to releasably receive shaft 90.

Complementary clamshell halves of flanges 122 may be fastened together for example, with an adhesive, screws such as metal screws, bolts, or other suitable fastener, to form a generally annular or cylindrical shape to circumscribe shaft 90 and attach to shaft 90 by way of friction fit. In some embodiments, flanges 122 may be affixed into shaft 90, for example, with an adhesive, screws, bolts, or other suitable fastener.

Flanges 122 may be formed of a rubber, polymer, metal, or other suitable material. Flanges 122 may be formed of a material with a relatively high coefficient of friction to provide sufficient friction when compressed against shaft 90 so as to constrain axial and rotational movement of flanges 122.

Complementary clamshell parts of collar body 124 may be attached together, for example, with screws, to form a generally cylindrical shape and to circumscribe shaft 90.

Collar body 124 may include insets or ridges, which may reduce the amount of material required during manufacturing, and may result in a lighter and structural component as compared to a cylinder without ridges.

The axial length of collar body 124 along shaft axis SA may be of a suitable length to provide desired structural stability.

Collar body 124 may be formed of a polymer, metal, or other suitable material.

Flanges 122 may constrain collar body 124 and prevent collar body 124 from moving axially along shaft axis SA and shaft 90, while allowing collar body 124 to rotate freely about shaft axis SA and shaft 90, illustrated as rotational movement A in FIG. 1.

In some embodiments, rotational movement A of collar body 124 may be constrained to a desired rotational movement. For example, rotational movement A of collar body 124 may be constrained to 120 degrees of rotation, such as 60 degrees in each direction from a generally vertical position with reference to transverse arm 140. Rotational movement A of collar 120 may be constrained by inserts 126. In some embodiments, rotational movement A of collar 120 may be constrained by stops such as a pin or screw.

Collar 120 may be sized with an inner diameter to circumscribe a shaft 90 having a diameter of 1.25 inches. The inner diameter of collar 120 may be sized to be suitable for shafts of other diameters. Inserts 126 may be used as shims to fit shafts of multiple dimensions. To fit a shaft of a thicker or thinner diameter, a user may switch out inserts 126 with thicker or thinner material to adjust the inner diameter of collar 120.

Collar body 124 of collar 120 may include a radially protruding eyelet 125, to which transverse arm 140 may be rotatably connected, for example, by way of a pin 130 extending through transverse arm 130 and eyelet 125.

Transverse arm 140 extends along a transverse axis TA from a first end to a second end opposite the first end. Transverse arm 140 is rotatably connected to collar 120 by way of pin 130 at the first end at a pivot axis PA. Transverse arm 140 may thus rotate about pivot axis PA, illustrated as rotational movement B in FIG. 1.

In some embodiments, transverse arm 140 includes a hollow cavity 142, sized to receive at least part of the length of an inner rod 144. As such, inner rod 144 may rotate within hollow cavity 142 and telescope in or out of hollow cavity 142, thus allowing transverse arm 140 to telescope to a desired extension or length.

Transverse arm 140 may be locked to a desired extension, for example, by way of a spring-loaded locking button or pin installed in inner rod 144 and extending radially through the wall of inner rod 144 and hollow cavity 142 at locations with pre-defined apertures along the axial length of hollow cavity 142. In other embodiments, transverse arm 140 may be locked to a desired extension by way of a twist lock. Other techniques for locking transverse arm 140 in a desired position, for example a lever lock, may be used.

Grip 160 extends from the second end of transverse arm 140.

Grip 160 may be shaped as a ©shaped handle, as shown in FIGS. 1 to 3. Grip 160 may be shaped to be grasped by a hand of a user, and may be formed of a material with a relatively high coefficient of friction, such as rubber or appropriate natural or synthetic polymer, graspable by the user. In some embodiments, grip 160 may be rigidly attached to transverse arm 140.

Grip 160 may be rotatably connected to transverse arm 140 such that grip 160 is rotatable about transverse axis TA, illustrated as rotational movement C in FIG. 1.

In some embodiments, transverse arm 140, in conjunction with grip 160, may telescope, as described above, and transverse arm 140 may extend or retract in length along transverse axis TA. Thus, grip 160 may be selectively axially movable along transverse axis TA, illustrated as axial movement D in FIG. 1.

Grip 160 may thus rotate about shaft axis SA of shaft 90, pivot axis PA, transverse axis TA of transverse arm 140, and move axially along transverse axis TA of transverse arm 140. Grip 160 of handle 100 may thus have four degrees of freedom of movement which may allow for multiple grip angles. Handle 100 may be configured to move and/or rotate about any or all of these degrees of freedom. This may allow better grip and rotation of the shovel by a user as compared to a user holding shaft 90 or other parts of the shovel alone.

Conveniently, handle 100 may allow for adjustable angles of an ergonomic attachment for long handle tools or shovels.

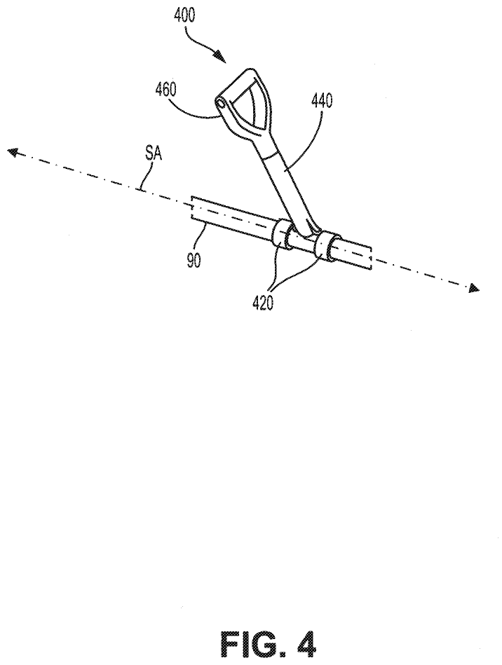

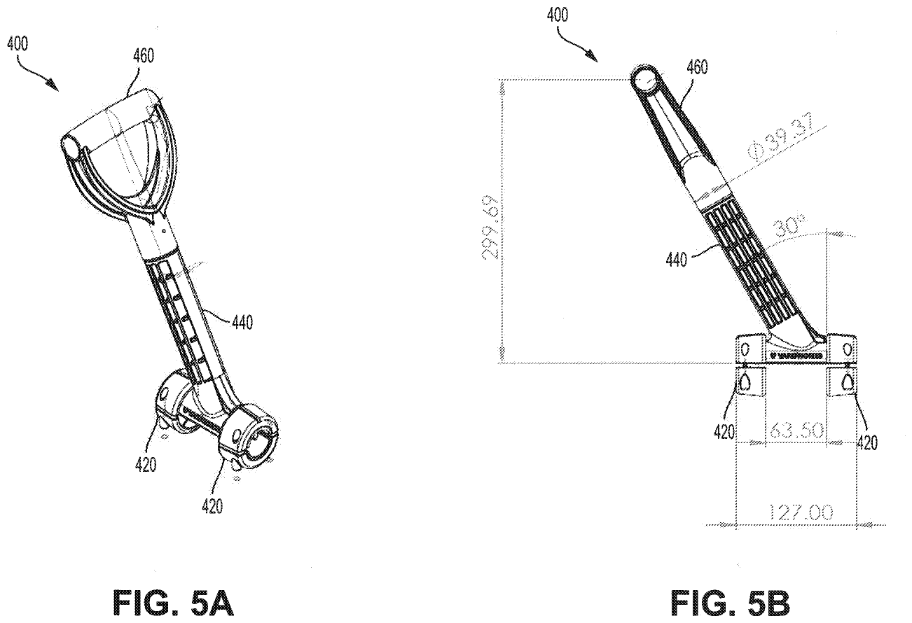

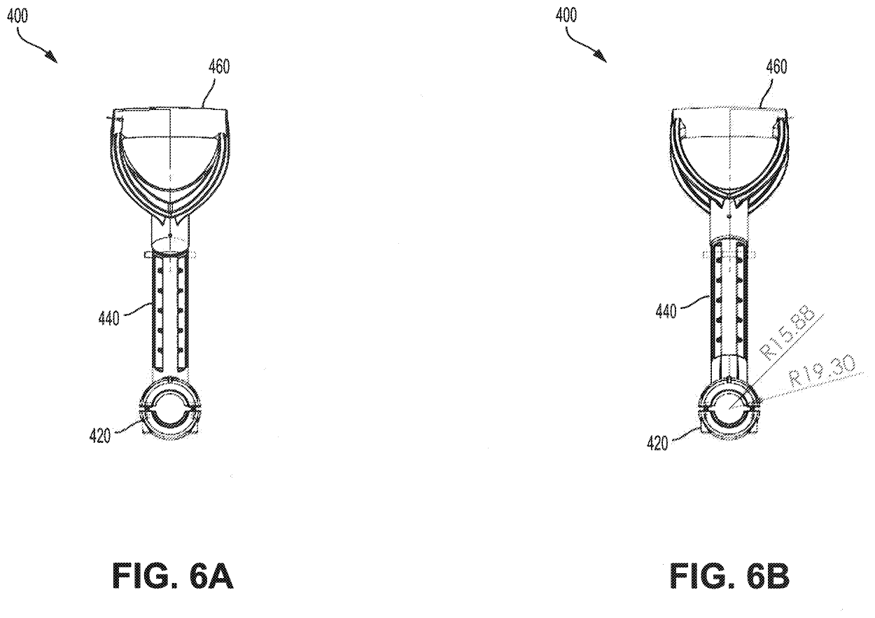

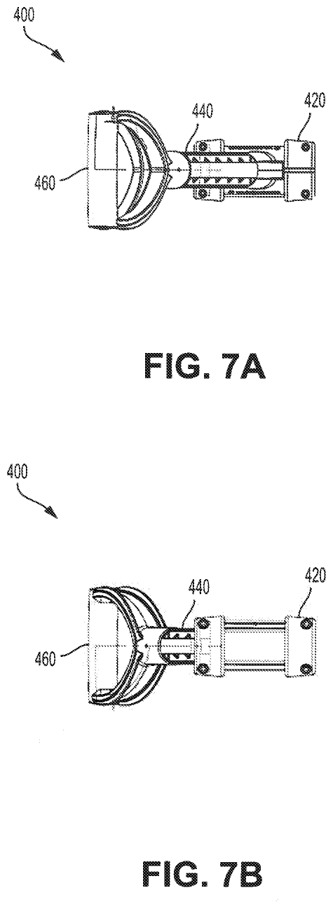

FIG. 4 illustrates a perspective view of a handle 400 mounted on shaft 90 in accordance with another embodiment. FIG. 5A is a perspective view of handle 400. FIG. 5B is a left side view of handle 400. FIG. 6A is back view of handle 400. FIG. 6B is a front view of handle 400. FIG. 7A is a top view of handle 400. FIG. 7B is a bottom view of handle 400.

Handle 400 may be similar in structure and components to handle 100. Handle 400 may include a collar 420, a transverse arm 440 and a grip 460.

Collar 420 may include two components affixed to shaft 90 in a similar manner to flanges 122 as described herein. Transverse arm 440 and grip 460 may be integrally formed, with transverse arm 440 including a cylindrical portion to circumscribe shaft 90 and rotate about shaft axis SA and grip 460 including a D-shaped handle. As such, grip 460 may be rotatable about shaft axis SA.

In use, handle 100 or handle 400 may be releasable coupled to shaft 90. Handle 100 or handle 400 may be used in combination with a shovel attached to shaft 90 for digging, lifting and moving materials such as dirt or snow by way of a manual or hand shovel action performed by a user.

As a load is applied to an end of shaft 90, for example, to the shovel blade, the rotation of shaft 90 with respect to grip 160 as grasped by a hand of a user may allow for additional leverage in moving the load, and allow the user to adjust or change their position during a shovelling movement in a suitable manner to avoid or change body strain.

The adjustable ergonomic grip provided by handle 100 or handle 400 attached to a shovel or other tool may reduce strain on a user's back during use. For example, the force of a load on the shovel blade may be redirected to a user's forearms.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A handle comprising:
a collar defining an opening to receive a shaft extending lengthwise along a shaft axis, the collar rotatable about the shaft axis;
a transverse arm extending along a transverse axis from a first end to a second end opposite the first end, the transverse arm rotatably connected to the collar at the first end; and
a grip extending from the second end of the transverse arm, the grip rotatable about the transverse axis.

2. The handle of claim 1, wherein the grip is selectively axially movable along the transverse axis.

3. The handle of claim 2, wherein the transverse arm telescopes to extend and retract in length.

4. The handle of claim 1, wherein the collar comprises two axially separated flanges fastenable to the shaft to constrain axial movement of the collar along the shaft axis.

5. The handle of claim 1, wherein the collar comprises two clamshell collar halves, the two clamshell collar halves attachable to each other.

6. The handle of claim 4, wherein each of the flanges comprises two clamshell flange halves, the two clamshell flange halves attachable to each other.

7. The handle of claim 1, wherein the grip is a D-shaped handle.

8. The handle of claim 1, wherein the shaft is connected to a fixed handle and a blade of a shovel.

9. The handle of claim 1, wherein the collar is rotatable 120 degrees about the shaft axis.
